(19) United States
(12) Patent Application Publication
(10) Pub. No.: US 2017/0215627 A1
(43) Pub. Date: Aug. 3, 2017

(54) COOL IMMENSIONED AND CENTRIFUGAL COFFEE BREWING MACHINE AND THE METHOD THEREOF

(71) Applicant: FATIA INDUSTRIAL COMPANY LIMITED, Kwai Chung, N.T. (HK)

(72) Inventor: Pui Yan FUNG, KWAI CHUNG, N.T. (HK)

(21) Appl. No.: 15/367,899

(22) Filed: Dec. 2, 2016

(30) Foreign Application Priority Data
Feb. 3, 2016 (HK) 16101281.8

(51) Int. Cl. A47J 31/22; A47J 31/06

(52) U.S. Cl. CPC A47J 31/22; A47J 31/06

(57) ABSTRACT

The present utility model discloses a cool immersed and centrifugal coffee brewing machine, includes a filtration cup arranged in a blender jar for accommodating coffee powder; and a stirring mechanism, rotating under driven, is arranged for driving coffee powder and water in the filtration cup to rotate, the centrifugal force formed by rotation and the rotating time are sufficient to brew coffee; a space is set between the filtration cup and the blender jar for accommodating coffee solution. The present utility model of cool immersed and centrifugal coffee brewing machine, due to adopting a stirring mechanism which is driven by a motor, drives the mixture of coffee powder and water to rotate rapidly, thus achieves a fast brewing of the cold soaking coffee through the centrifugal force, which is able to shorten the brewing time of cold soaking coffee from several hours to 10-30 minutes, therefore, it is more practical.

### FIELD OF THE INVENTION

The present invention relates to a coffee machine, and more particularly, to the improvement of a cool immersed and centrifugal coffee brewing machine.

### BACKGROUND

In the current technologies, when a coffee machine is making coffee brewing, a main implementation principle and method is shown in FIG. 1, it pours heated water 101 from the top down to a coffee powder deposition part, that is, a filtration cup, before brewing and preparation, wherein, the said heated water 101 may be sucked out from a water tank in the coffee machine, and heated by a corresponding heating unit during transportation, such as a heating tube, then, in order to control a water temperature, a temperature sensor and a control unit are required to be arranged accordingly to achieve a control to the water temperature.

However, there is always a plurality of requests on cold soaking coffee in the existing coffee demands, since some people may like to drink cold soaking coffee. But in the present art of cold soaking coffee preparations, due to using cold water to brew coffee, the brewing speed is very slow, for the coffee machines in the prior art usually needs a long time for the soaking process, which is generally over 10 hours; or a slow drip way may be taken, which also requires over 8 hours before being able to prepare a cup of cold coffee. The prior technology and preparation art for the cold soaking coffee is over cumbersome and time costing.

Therefore, the current technology needs to be improved and developed.

### BRIEF SUMMARY OF THE DISCLOSURE

The purpose of the present utility model is providing a cool immersed and centrifugal coffee brewing machine, pointing to the defections in the prior art, which is a better solution furtherly provided to accelerate the preparation process of cold coffee, and match a rapid supplying demand feature requested by the market, solving the problem of preparation time consumption to a cup of cold soaking coffee being too long, by providing a coffee machine being able to brew cold soaking coffee rapidly.

In order to achieve the above mentioned goals, the technical solution of the present utility model to solve the technical problems is as follows:

A cool immersed and centrifugal coffee brewing machine, includes a filtration cup to accommodate coffee powder, wherein, the said filtration cup is arranged in a blender jar; and a stirring mechanism rotating under driven is also arranged, applied to driving both the coffee powder and water to rotate in the said filtration cup, both a centrifugal force formed by rotation and rotation time are large enough to brew coffee; between the said filtration cup and the said blender jar, a space to accommodate coffee solution is arranged.

The cool immersed and centrifugal coffee brewing machine, wherein, the said coffee machine further has a coffee cup arranged below the said blender jar, applied to accommodating the coffee solution.

The cool immersed and centrifugal coffee brewing machine, wherein, between both the said coffee solution accommodation space and the said coffee cup, there are a one-way valve, a secondary filtration plate and a secondary one-way valve arranged.

The cool immersed and centrifugal coffee brewing machine, wherein, the said blender jar and the said one-way valve are arranged separately, and connecting the said one-way valve through bottom of the said blender jar.

The cool immersed and centrifugal coffee brewing machine, wherein, the said blender jar is arranged together with the said one-way valve, the said secondary filtration plate and the said secondary one-way valve, which is also arranged separately with the said coffee cup.

The cool immersed and centrifugal coffee brewing machine, wherein, the said stirring mechanism is arranged as a stirring rod structure driven by a motor, and a plurality of stirring blades are arranged on the said stirring rod.

The cool immersed and centrifugal coffee brewing machine, wherein, the said stirring mechanism is arranged as a motor driven impeller structure.

The cool immersed and centrifugal coffee brewing machine, wherein, the said filtration cup and/or the said secondary filtration plate is adopting a sieve over 400 meshes.

The cool immersed and centrifugal coffee brewing machine provided by the present utility model, due to adopting a stirring mechanism driven by a motor, drives a mixture of both coffee powder and water to rotate rapidly, thus achieves a fast brewing of the cold soaking coffee through the centrifugal force, which is able to shorten the brewing time cost for the cold soaking coffee from several hours to 10-30 minutes, therefore, it is more practical.

### BRIEF DESCRIPTION OF THE DRAWINGS

FIG. 1 illustrates a schematic diagram of a coffee brewing device in the current technology;

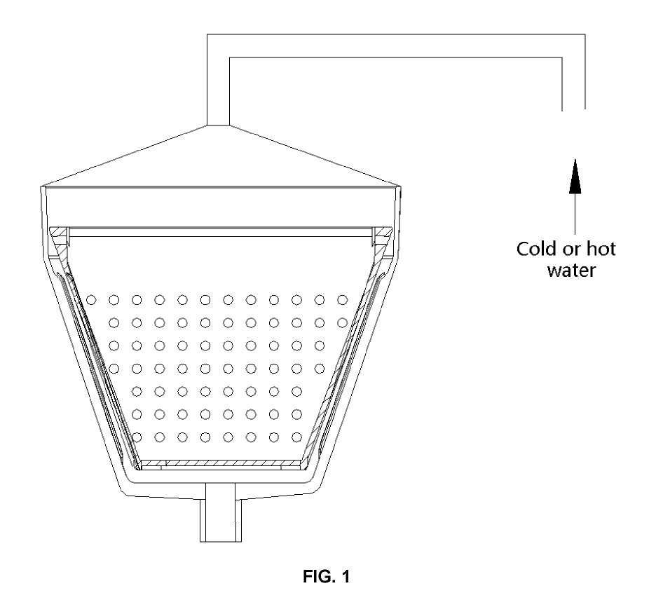

FIG. 2 illustrates a schematic diagram of the coffee machine and the brewing style coffee system with soaking and centrifuging provided by the first preferred embodiment of the present utility model;

FIG. 3 illustrates a schematic diagram of the coffee machine provided in the present utility model as illustrated in FIG. 2, when a brewing process is achieved and finished;

FIG. 4 illustrates a schematic diagram of the coffee machine and the brewing style coffee system with soaking and centrifuging provided by the second preferred embodiment of the present utility model;

FIG. 5 illustrates a schematic diagram of the coffee machine provided in the present utility model as illustrated in FIG. 4, after a brewing process is achieved and finished;

FIG. 6 illustrates a flow chart of the implementation method to the brewing process of the cold soaking coffee as provided in the present utility model.

### DETAILED DESCRIPTION

The present utility model provides a cool immersed and centrifugal coffee brewing machine, in order to make the purpose, technical solution and the advantages of the present utility model clearer and more explicit, further detailed descriptions of the present utility model are stated here, referencing to the attached drawings and some embodiments of the present utility model. It should be understood that the detailed embodiments of the utility model described here are used to explain the present utility model only, instead of limiting the present utility model.

The brewing style coffee machine in cold soaking and centrifuging way provided in the present utility model, belongs to an implementation method to brew cold soaking coffee and the application thereof, wherein, both coffee powder and water may be soaked with cold water in an accommodation container, and get rotating and rolling in a centrifugal way, which generates frictions between the coffee powder and water, and makes both substances contact thoroughly with convections, thereby shortens the time cost for cold soaking. In order to improve the efficiency of soaking, the coffee powder should be processed to a smaller particle size.

The coffee machine provided in the present utility model may brew the soluble substances in the coffee effectively, including the sweet and sour taste and the aroma thereof, as well as the non-soluble substances, including lipids and textures, so as to prepare cold soaking coffee rapidly. Comparing to the prior art, the cold soaking coffee preparation method provided in the present utility model, owns a specific long time cold and refreshing taste, which is suitable for a long time drinking.

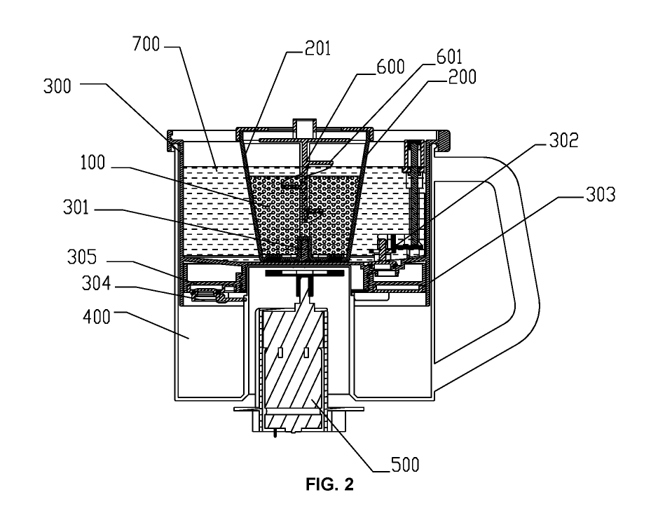

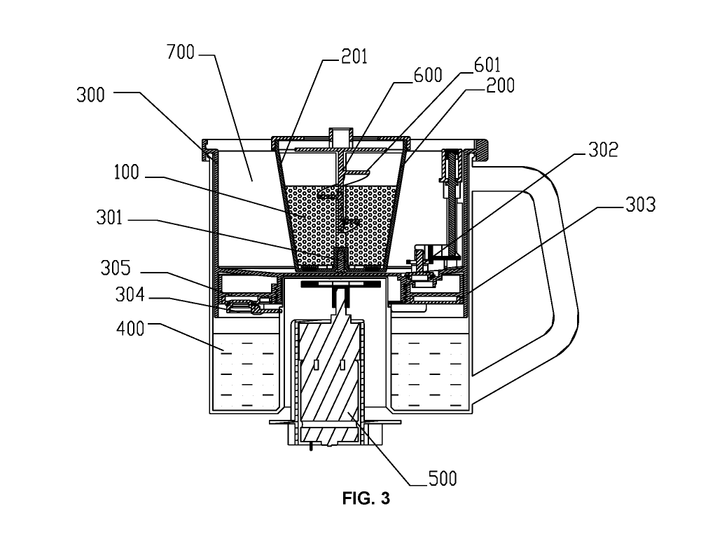

The cool immersed and centrifugal coffee brewing machine provided by the present utility model, as shown in FIG. 2 and FIG. 3, includes a filtration cup 200, applied to accommodating coffee powder 100, the said filtration cup 200 is arranged in a blender jar 300 on top of the coffee machine, applied to preparing the coffee, and there is a coffee cup 400 arranged below the said coffee machine, which is applied to accommodate coffee solution; a stirring rod 600 is arranged in the said blender jar 300, and a motor 500 is arranged under the said stirring rod 600 and the said blender jar 300, applied to drive the said stirring rod 600 to rotate. A plurality of blender blades 601 are arranged on the said stirring rod 600, so as to stir a mixture of the coffee powder 100 and water in the said stirring jar after the said stirring rod 600 is rotating, and the mixture is then driven to rotate and form a centrifugal movement. In other different implementations, the said filtration cup provided in the present utility model may be driven by the said motor, and the said stirring mechanism is arranged in the said filtration cup, which rotates together with and under driven by the said filtration cup.

The coffee machine apparatus as provided in the present utility model, wherein, it is possible but not limited to that, a plurality of sieves 201 with 400 meshes or above are embedded around the said filtration cup 200, to filtrate the coffee powder; the filtration cup 200 is placed on a rotation axle 301 locating at the center of the blender jar 300, while the said rotation axle 301 is rotating in a speed of 200-500 rounds per minute under the driven by the said motor 500. Rotation of both the filtration cup 200 and the stirring rod 600 may make both the coffee powder 100 and the water 700 contact and convent thoroughly and effectively, while the centrifugal force induced by rotation may accelerate the separation process in coffee brewing, thus a purpose of reducing the time cost for cold soaking coffee brewing is achieved. And a plurality of spaces are arranged between the said filtration cup 200 and the said blender jar 300, applied to accommodating coffee solution after brewing.

The coffee machine apparatus provided in the present utility model, wherein, a one-way valve 302, a secondary filtration plate 303, a secondary one-way valve 304 are further arranged on the bottom of the said blender jar 300. In the said secondary filtration plate 303, there are stainless steel sieves 305 with 400-600 meshes embedded, to achieve a further filtration process. After finishing the preparation of the said cold soaking coffee provided in the present utility model, the one-way valve 302 opens, and the coffee mixture flows into the secondary filtration plate 303, after a second filtration by the said stainless steel sieve 305, it flows into the coffee cup 400 through the secondary one-way valve 304, and a purpose of separating the coffee solution and a plurality of coffee grounds is achieved. When a user takes out the blender jar 300, the secondary one-way valve 304 will get closed automatically, to prevent the coffee solution left from dripping everywhere and polluting the countertop or ground top in the kitchen.

In the said first preferred embodiment of the coffee machine apparatus, as provided in the present utility model, the said coffee cup 400 is arranged beneath the said coffee machine, applied to accommodating the separated cold soaking coffee solution, while playing a role of supporting the stirring cup 300.

The said stirring rod 600 as provided in the present utility model may be applied to stirring the coffee powder 100 under the driving of the said motor 500 and the according rotation axle 301, which makes the coffee powder 100 roll in the filtration cup 200, thus making the coffee powder 100 and water 700 contact thoroughly and effectively. With the help of both the whole water rotation in the blender jar 300, and the high speed rotation of the mixture of both coffee powder and water in the said filtration cup 200, a centrifuging and brewing action will be formed, that achieves accelerating the brewing process of cold soaking coffee.

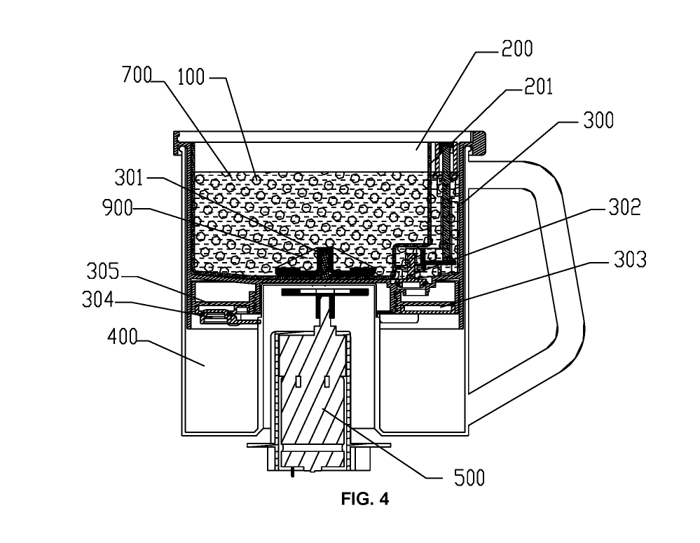

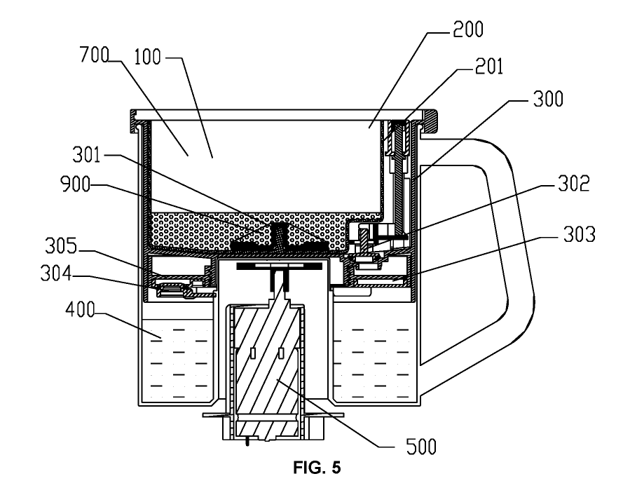

A second preferred embodiment of the coffee machine apparatus as provided in the present utility model, as shown in FIG. 4 and FIG. 5, it includes a filtration cup 200 applied to accommodating the coffee powder 100, a blender jar 300 applied to preparing the coffee, the said filtration cup 200 is designed larger than that in the first preferred embodiment, as well as a coffee cup 400 applied to accommodating the coffee solution, a motor 500 and an impeller 900. Around the said filtration cup 200, there is a plurality of sieves 201 with 400 meshes or above embedded, to achieve a filtration function for the coffee powder 100. The said impeller 900 is arranged on the central axis 301 of the said filtration cup 200, and is able to make a high speed rotation under driven of the said motor 500.

As shown in FIG. 4 and FIG. 5, the said motor 500 drives the said impeller 900 to rotate in a high speed, thus it may drive both coffee powder 100 and water 700 in the said filtration cup 200 to rotate in a high speed, therefore, making the coffee powder 100 and water 700 contact and convent thoroughly and effectively, while the centrifugal force induced by the rotation may accelerate the separation of coffee brewing, thus the purpose of lowering the time cost for cold soaking coffee brewing is achieved. Between the said filtration cup 200 and the said blender jar 300, there is the filtration solution arranged together with tiny coffee grounds, so a further filtration is required. In the second preferred embodiment of the present utility model, capacity of the said filtration cup 200 is selected larger than that arranged in the first embodiment, and an impeller 900 is adopted as the stirring mechanism, while in the first preferred embodiment, it is adopting the stirring rod 600.

Same as the first preferred embodiment, the said coffee machine apparatus provided in the present utility model, wherein, there are a one-way valve 302, a secondary filtration plate 303 and a secondary one-way valve 304 furtherly arranged on the bottom of the said blender jar 300, so as to make the coffee solution flow into the said coffee cup 400 sequent through the said one-way valve 302, the said secondary filtration plate 303 and the said secondary one-way valve 304. In the said secondary filtration plate 303, there are sieves 305 with 400 meshes or above embedded. After preparing the said cold soaking coffee as provided in the present utility model is finished, the one-way valve 302 will be open, and the coffee mixture will flow into the secondary filtration plate 303, after a secondary filtration by the said sieves 305, it will flow into the coffee cup 400 through the secondary one-way valve 304, and a purpose of separating the coffee solution and the coffee grounds is then achieved. Opening and closing the said one-way valve 302 may be achieved by software controlling, may also be achieved by a mechanical structure. In the second preferred embodiment of the present utility model, it may arrange both the said blender cup 300 and the said one-way valve structure together, therefore, when a user is taking the blender jar 300 out, the said secondary one-way valve 304 will close automatically to prevent the coffee solution left from dripping everywhere and polluting the countertop or ground top in the kitchen.

In the said coffee machine apparatus provided in the present utility model, the said coffee cup 400 is applied to accommodating the coffee solution after separating, as well as supporting the blender jar 300. The said impeller 900 is applied to stirring the coffee powder 100 and water 700, making the mixture of coffee powder 100 and water 700 rotate and roll thoroughly in the filtration cup 200, making the coffee powder 100 and water 700 contact thoroughly and effectively, finally speeding up the process of cold soaking and brewing under driven of the centrifugal force.

The coffee machine apparatus provided in the present utility model further discloses a brewing method for cold soaking coffee, although the present utility model is pointing to the improvement for cold soaking coffee preparation method, the coffee machine apparatus is also able to be applied to coffee brewing processes other than cold soaking coffee, obviously, it is not limited to cold soaking coffee, as long as it is a coffee brewing method adopting centrifugal forces, it should be covered by the protection range of the present utility model.

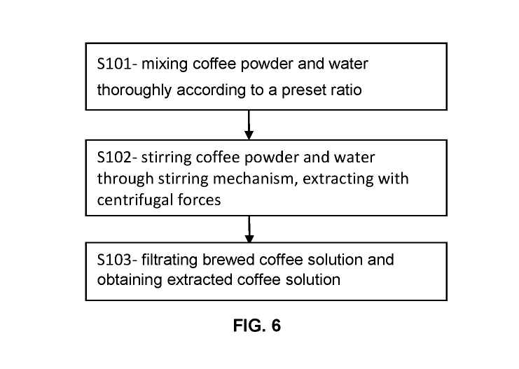

The coffee brewing method with cold soaking and centrifuging, as shown in the flow chart of FIG. 6, wherein, it includes: S101, mixing the coffee powder and water thoroughly; S102, stirring the coffee powder and water through the stirring mechanism, and making the mixture rotate and form a rolling of the solution, as well as brewing the coffee with centrifugal forces; S103, filtrating the coffee extraction solution at least once, and preferably, filtrating at least twice adopting both the filtration cup and the sieve, before finally achieving the coffee solution after brewing. The method of coffee brewing process under centrifugal forces, may speed up the brewing process of the coffee, it may also be applied to non-cold soaking coffee preparations, which may improve the coffee brewing process, thus speed up the preparation process of hot coffee.

The said implementation method provided in the present utility model, wherein, pouring a proper amount of coffee powder into the said filtration cup, and a ratio of the powder to water could be set between 55 g-66 g:1000 ml; pouring a proper amount of water into the said blender jar; the water temperature is set between 0-25° C., and the hardness value of the water is set between 100-250 ppm; the said control switch controls the motor to rotate in an intermittent mode or a reciprocal mode, making the filtration cup rotate in an intermittent mode or a reciprocal mode in the blender jar; keeping the stirring mechanism rotating for 10-30 minutes, it may also adopt a method of the filtration cup rotating and keeping for a preset time; opening the said one-way valve, and making the coffee solution flow into a secondary filtration plate from the blender jar, before flowing into the coffee cup after secondary filtration, and separating the coffee solution and coffee grounds.

The method provided in the present utility model, wherein, during the coffee brewing process of using a principle of soaking and centrifuging forces generated by the coffee powder rotating driven by the said filtration cup, the water may be room temperature or below, such as a water temperature between 0-20° C.

Due to the coffee machine apparatuses in both embodiments in the present utility model are adopting an implementation method of brewing coffee in a soaking and centrifuging way, the coffee brewing ability using water in room temperature or low temperature is greatly improved, and the brewing time may be shorten to 10-30 minutes, while the effective gradients in the coffee powder may also be effectively extracted. In order to achieve different tastes of the coffee, different temperatures of the water, as well as the rotation speeds of the said motor, and the lengths of the rotation periods, together with the different intermittent modes according to different rotation speeds and more, may be adjusted, to make the cold soaking coffee different tastes, and detailed implementation methods are waiting for further researches and improvements.

In the selection modes of the coffee machine in the present utility model, it may arrange a control switch to select and achieve cold soaking coffee in different tastes, which may be achieved through controlling the rotation directions of the coffee powder and water, as well as the period length of the intermittent rotations, so as to soak cold soaking coffee in different flavors.

The implementation method of the brewing style coffee machine in cold soaking and centrifuging way, and the coffee machine apparatus thereof, wherein, the coffee machine apparatus described in the first preferred embodiment comprises a filtration cup applied to accommodating the coffee powder, a blender jar applied to preparing coffee, a coffee cup applied to accommodating coffee solution, a driving motor and a stirring rod; the coffee machine apparatus in the second preferred embodiment comprises a filtration cup for accommodating the coffee powder, a blender jar for preparing coffee, a coffee cup for accommodating the coffee solution, a driving motor and an impeller. The motor of the said coffee machine apparatus may be applied to control to achieve different rotation modes in either an intermittent mode or a reciprocal mode through selecting different control switches, and drive the coffee powder and water in the blender jar of the coffee machine to rotate and roll in the same intermittent mode or reciprocal mode, so as to build frictions between the coffee powder and water, making them contact and convent thoroughly, before separating the effective gradients in the coffee rapidly under the action of centrifugal forces, which may greatly shorten the cold soaking time, and improve the brewing efficiency of cold soaking coffee, thus has shortened the coffee brewing period to 10-30 minutes, it is especially suitable to the cold soaking coffee preparing process in a coffee shop or other business places.

Due to the present utility model adopting an implementation method of brewing coffee in a soaking and centrifuging way according to the preparation process of cold soaking coffee, it may accelerate and improve the extraction rate, thus speed up the preparation process of cold soaking coffee, which is an improvement to cold soaking coffee brewing apparatus and the method thereof.

It should be understood that, the application of the present utility model is not limited to the above examples listed. Ordinary technical personnel in this field can improve or change the applications according to the above descriptions, all of these improvements and transforms should belong to the scope of protection in the appended claims of the present utility model.

What is claimed is:

1. A cool immersed and centrifugal coffee brewing machine, includes a filtration cup to accommodate coffee powder, wherein, the filtration cup is arranged in a blender jar; and a stirring mechanism rotating under driven is also arranged, applied to driving both the coffee powder and water to rotate in the filtration cup, both a centrifugal force formed by rotation and rotation time are large enough to brew coffee; between the filtration cup and the blender jar, a space to accommodate coffee solution is arranged.

2. The cool immersed and centrifugal coffee brewing machine according to claim 1, wherein, the coffee machine further has a coffee cup arranged below the blender jar, applied to accommodating the coffee solution.

3. The cool immersed and centrifugal coffee brewing machine according to claim 2, wherein, between both the coffee solution accommodation space and the coffee cup, there are a one-way valve, a secondary filtration plate and a secondary one-way valve arranged.

4. The cool immersed and centrifugal coffee brewing machine according to claim 3, wherein, the blender jar and the one-way valve are arranged separately, and connecting the one-way valve through bottom of the blender jar.

5. The cool immersed and centrifugal coffee brewing machine according to claim 3, wherein, the blender jar is arranged together with the one-way valve, the secondary filtration plate and the secondary one-way valve, which is also arranged separately with the coffee cup.

6. The cool immersed and centrifugal coffee brewing machine according to claim 4, wherein, the stirring mechanism is arranged as a stirring rod structure driven by a motor, and a plurality of stirring blades are arranged on the stirring rod.

7. The cool immersed and centrifugal coffee brewing machine according to claim 4, wherein, the stirring mechanism is arranged as a motor driven impeller structure.

8. The cool immersed and centrifugal coffee brewing machine according to claim 4, wherein, the filtration cup and/or the secondary filtration plate is adopting a sieve over 400 meshes.

9. The cool immersed and centrifugal coffee brewing machine according to claim 5, wherein, the stirring mechanism is arranged as a stirring rod structure driven by a motor, and a plurality of stirring blades are arranged on the stirring rod.

10. The cool immersed and centrifugal coffee brewing machine according to claim 5, wherein, the stirring mechanism is arranged as a motor driven impeller structure.

11. The cool immersed and centrifugal coffee brewing machine according to claim 5, wherein, the filtration cup and/or the secondary filtration plate is adopting a sieve over 400 meshes.
